(19) United States
(12) Patent Application Publication
(10) Pub. No.: US 2009/0246520 A1
(43) Pub. Date: Oct. 1, 2009

(54) COMPOSITION FOR PRODUCING HIGH HEAT RESISTANCE INSULATING MATERIAL AND INSULATED CABLE HAVING THE SAME

(75) Inventors: Do-Hyun Park, Gyeonggi-do (KR); In-Hwoi Lee, Seoul (KR)

Correspondence Address: JONES DAY, 222 EAST 41ST ST, NEW YORK, NY, 10017, US

(73) Assignee: LS Cable Ltd.

(21) Appl. No.: 12/342,320

(22) Filed: Dec. 23, 2008

(30) Foreign Application Priority Data
Mar. 28, 2008 (KR) 10-2008-0028893

(51) Int. Cl. B32B 5/02; E04B 1/74

(52) U.S. Cl. 428/365; 252/62

(57) ABSTRACT

The present invention relates to a composition for producing a high heat resistance insulating material, and an insulated cable having the same. A composition for producing a high heat resistance insulating material according to the present invention comprises 0.5 to 10 parts by weight of a crosslinking agent based on 100 parts by weight of a fluorine-based rubber. The present invention provides an insulated cable that is capable of sending more electric current at least twice than an allowable current capacity based on a cross-sectional area of a conductor of a conventional cable. Therefore, the present invention can reduce an outer diameter of an insulated cable by 30% or more and the weight by 40% or more in comparison with the conventional cable, and thus provides the insulated cable with lightweight and flexibility.

### TECHNICAL FIELD

The present invention relates to a composition for producing a high heat resistance insulating material and a high heat resistance insulated cable having the same, and in particular, to a composition for producing a high heat resistance insulating material, which may be used to form an insulating layer or a sheath layer for ensuring voltage resistance or heat resistance under conditions that a maximum allowable current value of a center conductor is high and for improving flexibility, and a high heat resistance insulated cable having the same.

### BACKGROUND

Conventionally, an electric wire for power supply used in an equipment or a vehicle should use a conductor of a proper standard or more according to applied voltage and current. In particular, for flow of current of a predetermined capacity or more, a conductor should have a cross-sectional area of a predetermined standard or more in consideration that the conductor generates heat due to resistance of the conductor. The temperature of an electric wire or a cable is increased by influence of an ambient temperature where it is installed. Thus, for flow of current of a predetermined capacity, the conductor should have a large cross-sectional area. Recently, a cable used in an electronic equipment or a vehicle is confronted with the demand for miniaturization and lightweight. In particular, to install the cable in a small space, the cable should have the reduced outer diameter and the improved flexibility.

For easy installation and flexibility of a cable, conventionally the size of a conductor was reduced and the conductor was surrounded with an insulating material, for example a polyvinylchloride (PVC) resin or a crosslinked polyethylene (PE) or polyolefin. However, if the current capacity increases, the conductor generates heat, whereby an insulator surrounding the conductor may melt or break after a long-term use. As a result, an accident such as a fire or an electric shock may occur due to a short circuit. To solve the problems, an attempt has been made to use a heat resistance resin having high melting temperature as an insulating material. However, a heat resistance resin having high melting temperature such as engineering plastics is a crystalline resin, and thus it has high stiffness and modulus at normal temperature. Accordingly, flexibility of a cable with the heat resistance resin having high melting temperature is reduced, consequently it is difficult to obtain an easiness in installation.

The related industry has attempted to solve the problems regarding heat resistance and easiness in installation, and the present invention was devised under this technical background.

### SUMMARY

It is an object of the present invention to provide a composition for producing a high heat resistance insulating material which increases a maximum allowable current capacity based on a cross-sectional area of a center conductor of a cable, maintains a sufficient resistance to heat generated from the center conductor, and gives flexibility to an insulating layer surrounding the center conductor to obtain an easiness in installation, and an insulated cable having the same.

A composition (hereinafter referred to as ‘a first composition’) for producing a high heat resistance insulating material according to the present invention comprises 0.5 to 10 parts by weight of a crosslinking agent based on 100 parts by weight of a fluorine-based rubber. Meanwhile, preferably the first composition is used to form a high heat resistance insulating layer that surrounds an outer surface of a center conductor of an insulated cable.

A composition (hereinafter referred to as ‘a second composition’) for producing a high heat resistance insulating material according to the present invention comprises 0.5 to 10 parts by weight of a crosslinking agent based on 100 parts by weight of a basic resin that is at least one selected from the group consisting of an ethylene-based copolymer resin, a polyethylene-based resin, a styrene-based resin, a rubber, polypropylene, a polyester resin, a chloropolyethylene resin and a chlorosulfonated polyethylene. Meanwhile, preferably, the second composition is used to form a sheath layer, wherein a high heat resistance insulated cable comprises a center conductor, an insulating layer surrounding the center conductor, a fabric layer surrounding the insulating layer, and the sheath layer surrounding the fabric layer and serving as an outermost layer.

A high heat resistance insulated cable according to the present invention comprises a center conductor, an insulating layer surrounding the center conductor, a fabric layer surrounding the insulating layer, and a sheath layer surrounding the fabric layer and serving as an outermost layer. Preferably, the insulating layer is formed using the first composition, and the sheath layer is formed using the second composition.

### BRIEF DESCRIPTION OF THE DRAWINGS

The present invention will be more fully described in the following detailed description, taken accompanying drawings, however, the description proposed herein is just a preferable example for the purpose of illustrations, not intended to limit the scope of the invention.

FIG. 1 is a cross-sectional view illustrating a configuration of an insulated cable according to the present invention.

### DETAILED DESCRIPTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

A first composition for producing a high heat resistance insulating material according to the present invention comprises 0.5 to 10 parts by weight of a crosslinking agent based on 100 parts by weight of a fluorine-based rubber. In the case that the content of the crosslinking agent is less than the above-mentioned minimum, it is not preferable because the required tensile strength and heat resistance at high temperature are not obtained. In the case that the content of the crosslinking agent is more than the above-mentioned maximum, it is not preferable because elongation is rapidly reduced and a scotch phenomenon occurs due to heat during an extrusion process.

Preferably, the fluorine-based rubber is any one selected from the group consisting of vinylidenefluoride hexafluoropropylene, vinylidenefluoride hexafluoropropylene tetrafluoroethylene, tetrafluoroethylene propylene, tetrafluoroethylene propylene vinylidenefluoride, tetrafluoroethylene perfluoromethylvinylether vinylidenefluoride and tetrafluoroethylene hexafluoropropylene ethylene perfluoromethylvinylether vinylidenefluoride, or mixtures thereof, however the present invention is not limited in this regard. Preferably, the crosslinking agent is any one selected from the group consisting of di-(2,4-dichlorobenzoyl)-peroxide, dibenzoyl peroxide, tert-butyl peroxybenzoate, 1,1-di-(tert-butylperoxy)-3,3,5-trimethylcyclohexane, dicumyl peroxide, tert-butylcumylperoxide, di-(2-tert-butyl-peroxyisopropyl)-benzene, 2,5-dimethyl-2,5-di-(tert-butylperoxy)-hexane, di-tert-butylperoxide and 2,5-dimethyl-2,5-di(tert-butylperoxy)hexyne-3, or mixtures thereof, however the present invention is not limited in this regard. Preferably, the first composition is used to form a high heat resistance insulating layer that surrounds an outer surface of a center conductor of an insulated cable.

A second composition for producing a high heat resistance insulating material according to the present invention comprises 0.5 to 10 parts by weight of a crosslinking agent based on 100 parts by weight of a basic resin that is any one selected from the group consisting of an ethylene-based copolymer resin, a polyethylene-based resin, a styrene-based resin, a rubber, polypropylene, a polyester resin, a chloropolyethylene resin and a chlorosulfonated polyethylene, or mixtures thereof. In the case that the content of the crosslinking agent is less than the above-mentioned minimum, it is not preferable because the required tensile strength, and heat resistance and wear resistance at high temperature are not obtained. In the case that the content of the crosslinking agent is more than the above-mentioned maximum, it is not preferable because elongation is rapidly reduced.

Preferably, the ethylene-based copolymer resin selected as the basic resin is any one selected from the group consisting of ethylene vinyl acetate copolymer, ethylene ethyl acrylate copolymer, ethylene methyl acrylate copolymer, ethylene butyl acrylate copolymer, ethylene alcohol acrylate copolymer, ethylene butylene copolymer and ethylene octene copolymer, or mixtures thereof, however the present invention is not limited in this regard.

Preferably, the polyethylene-based resin selected as the basic resin is any one selected from the group consisting of low density polyethylene, linear low density polyethylene, medium density polyethylene and high density polyethylene, or mixtures thereof, however the present invention is not limited in this regard.

Preferably, the styrene-based resin selected as the basic resin is any one selected from the group consisting of styrene butylene styrene resin, styrene ethylene butylene styrene resin, styrene ethylene propylene styrene resin, or mixtures thereof, however the present invention is not limited in this regard.

Preferably, the rubber selected as the basic resin is any one selected from the group consisting of an ethylene propylene rubber and a chloropropylene rubber, or mixtures thereof, however the present invention is not limited in this regard.

Preferably, the crosslinking agent is any one selected from the group consisting of di-(2,4-dichlorobenzoyl)-peroxide, dibenzoyl peroxide, tert-butyl peroxybenzoate, 1,1-di-(tert-butylperoxy)-3,3,5-trimethylcyclohexane, dicumyl peroxide, tert-butylcumylperoxide, di-(2-tert-butyl-peroxyisopropyl)-benzene, 2,5-dimethyl-2,5-di-(tert-butylperoxy)-hexane, di-tert-butylperoxide and 2,5-dimethyl-2,5-di(tert-butylperoxy)hexyne-3, or mixtures thereof, however the present invention is not limited in this regard.

Preferably, the second composition for producing a high heat resistance insulating material is used to form a sheath layer, wherein an insulated cable comprises a center conductor, an insulating layer surrounding the center conductor, a fabric layer surrounding the insulating layer, and the sheath layer surrounding the fabric layer and serving as an outermost layer.

A high heat resistance insulated cable according to the present invention comprises a center conductor, an insulating layer surrounding the center conductor, a fabric layer surrounding the insulating layer, and a sheath layer surrounding the fabric layer and serving as an outermost layer. The insulating layer may be formed using the above-mentioned first composition for producing a high heat resistance insulating material, and the sheath layer is formed using the above-mentioned second composition for producing a high heat resistance insulating material.

Hereinafter, excellent effects of the present invention are specified using examples and comparative examples. Each cable sample was manufactured for the examples and comparative examples, and several properties of the cable sample were evaluated.

The following Table 1 has examples 1 to 4 set in the range of the above-mentioned first composition and comparative examples 1 to 3 set for comparison with the examples of the present invention. A composition was prepared according to ingredients and content shown in the Table 1, and an insulated cable was manufactured by forming an insulating layer surrounding a center conductor using the prepared composition.

TABLE 1

| | | | | | Comparative | | |
|---|---|---|---|---|---|---|---|
| | Examples | | | | examples | | |
| Classification | 1 | 2 | 3 | 4 | 1 | 2 | 3 |
| Vinylidenefluoride | 100 | | | | | | |
| hexafluoropropylene | | | | | | | |
| Vinylidenefluoride | | 100 | | | | | |
| hexafluoropropylene | | | | | | | |
| tetrafluoroethene | | | | | | | |
| Tetrafluoroethene | | | 100 | | | | |
| propylene | | | | | | | |
| vinylidenefluoride | | | | | | | |
| Tetrafluoroethylene | | | | 100 | | | |
| propylene | | | | | | | |
| vinylidene difluoride | | | | | | | |
| Polyvinylchloride | | | | | 100 | | |
| Crosslinked low | | | | | | 100 | |
| density polyethylene | | | | | | | |
| Crosslinked | | | | | | | 100 |
| polyolefin | | | | | | | |
| Crosslinking agent | 4 | 4 | 4 | 4 | 4 | 4 | 4 |

A withstanding voltage after heating and a maximum allowable current value of each insulated cable manufactured according to the Table 1 were measured, and the results are shown in the following Table 2. A withstanding voltage test was performed by heating the insulated cable at 225° C. for 240 hours as a material having a maximum continuous operating temperature of 200° C. under temperature conditions of 180° C. or more and determining whether its characteristics are maintained or not, and by heating the insulated cable at 200° C. for 3,000 hours and determining whether its withstanding voltage characteristics are satisfied when 2.5 kV is applied.

TABLE 2

| | Examples | | | | Comparative examples | | |
|---|---|---|---|---|---|---|---|
| Classification | 1 | 2 | 3 | 4 | 1 | 2 | 3 |
| Withstanding | pass | pass | pass | pass | fail | fail | fail |
| voltage test | | | | | | | |
| after heating | | | | | | | |
| Allowable | ~350 | ~350 | ~350 | ~350 | ~180 | ~230 | ~230 |
| current (mA) | | | | | | | |

As shown in Table 2, the examples 1 to 4 passed the withstanding voltage test after heating, but the comparative examples 1 to 3 exhibited a breakage phenomenon of an insulator and thus failed the withstanding voltage test. And, allowable current values of the examples 1 to 4 were higher at least 1.5 times than those of the comparative examples 1 to 3. Accordingly, it was found that the first composition according to the present invention exhibits a high heat resistance.

The following Table 3 has examples 5 to 8 set in the range of the above-mentioned second composition and comparative examples 4 to 6 set for comparison with the examples of the present invention. A composition was prepared according to ingredients and content shown in the Table 3, and a sample for a sheath layer of an insulated cable was manufactured using the prepared composition.

TABLE 3

| | Examples | | | | Comparative examples | | |
|---|---|---|---|---|---|---|---|
| Classification | 5 | 6 | 7 | 8 | 4 | 5 | 6 |
| Ethylene vinyl | 100 | 70 | | | | | |
| acetate | | | | | | | |
| copolymer | | | | | | | |
| Ethylene methyl | | | 100 | | | | |
| acrylate | | | | | | | |
| copolymer | | | | | | | |
| Ethylene ethyl | | | | 100 | | | |
| acrylate | | | | | | | |
| copolymer | | | | | | | |
| Ethylene octene | | 30 | | | | | |
| copolymer | | | | | | | |
| Polyvinylchloride | | | | | 100 | | |
| Linear low | | | | | | 100 | |
| density | | | | | | | |
| polyethylene | | | | | | | |
| High density | | | | | | | 100 |
| polyethylene | | | | | | | |
| Plasticizer | | | | | 50 | | |
| Crosslinking | 4 | 4 | 4 | 4 | 4 | 4 | 4 |
| agent | | | | | | | |

A polymer material sample that can be used to form a sheath layer of an insulated cable was prepared for each example and comparative example by mixing ingredients shown in Table 3 with content shown in Table 3 in an open roll at about 130° C. and molding the mixture using a presser of 170° C. for 20 minutes. Each of the prepared samples was tested in aspect of heating characteristics, modulus and Young's modulus, and the results are shown in Table 4.

At this time, after the sample was heated at 180° C. for 168 hours, the heating characteristics including remaining tensile strength ratio (%) and remaining elongation ratio (%) were measured. Modulus was measured during a tensile strength test of 250 mm/min. Young's modulus was measured during a tensile strength test of 250 mm/min.

TABLE 4

| | | Examples | | | | Comparative examples | | |
|---|---|---|---|---|---|---|---|---|
| Classification | | 5 | 6 | 7 | 8 | 4 | 5 | 6 |
| After | Remaining tensile | 87 | 91 | 85 | 87 | 53 | 96 | 99 |
| heating | strength ratio (%) | | | | | | | |
| | Remaining elongation | 85 | 88 | 84 | 83 | 5 | 47 | 56 |
| | ratio (%) | | | | | | | |

| | | | | | | | |
|---|---|---|---|---|---|---|---|
| Modulus (kgf/mm²) | 0.63 | 0.67 | 0.67 | 0.71 | 3.9 | 4.6 | 5.4 |
| Young's modulus (kgf/ | 612 | 925 | 683 | 706 | 4163 | 4782 | 6340 |
| mm²) | | | | | | | |

The measured property values shown in Table 4 are evaluated according to the following standards. That is, a remaining tensile strength ratio of 60% or more is suitable for a product, and a remaining elongation ratio of 50% or more is suitable for a product. And, modulus of 1.5 kgf/mm² or less is suitable for a product under conditions of elongation of 10% and Young's modulus of 2500 kgf/mm² or less is suitable for a product under conditions of elongation of 10%.

In review of the above-mentioned standards, it was found that the examples 5 to 8 using a low-crystalline resin exhibited the measured values beyond the standards, and thus are suitable for a product. However, the comparative examples 4 to 6 using a crystalline resin had a suitable heat resistance, but exhibited modulus and Young's modulus under the standards due to the crystalline resin. Therefore, it was found that a sheath layer of an insulated cable formed using the second composition according to the present invention has excellent effects.

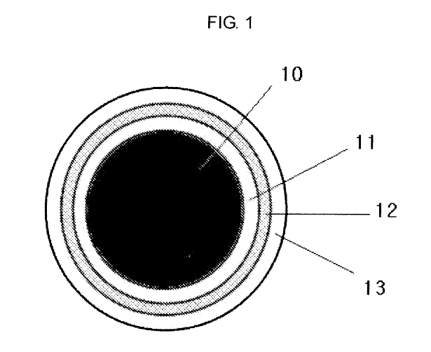

FIG. 1 is a cross-sectional view illustrating a configuration of an insulated cable according to the present invention.

As shown in FIG. 1, the insulated cable comprises a center conductor 10 and an insulating layer 11 made of a fluorine rubber, surrounding the center conductor 10. A predetermined film (not shown) may be interposed between the center conductor 10 and the insulating layer 11 for smooth separation of the center conductor 10 and the insulating layer 11. Preferably, the insulating layer 11 is formed using the above-mentioned first composition. Meanwhile, the insulating layer 11 is surrounded with a fabric layer 12 made of copper plated with copper, tin or zinc. The fabric layer 12 is surrounded with a sheath layer 13. The sheath layer 13 is an outermost layer of the insulated cable. Preferably, the sheath layer 13 is made of a material having heat resistance and elastic modulus and Young's modulus characteristics at normal temperature, that is, the above-mentioned second composition.

As such, the insulated cable comprising the insulating layer 11 made of the first composition and the sheath layer 13 made of the second composition can be used as a cable for various equipments and vehicles. The insulated cable according to the present invention can increase an allowable current capacity of a conductor at least 1.5 times than a conventional insulated cable.

Therefore, the present invention provides an insulated cable that is capable of sending more electric current at least twice than an allowable current capacity based on a cross-sectional area of a conductor of a conventional cable. And, the present invention can reduce an outer diameter of an insulated cable by 30% or more and the weight by 40% or more in comparison with the conventional cable, and thus provides the insulated cable with lightweight and flexibility. In the case that the composition according to the present invention is used to form an insulating layer or a sheath layer of an insulated cable, compatibility is improved in aspect of high heat resistance, an allowable current capacity of a conductor is increased at least 1.5 times, and flexibility of the insulating layer or the sheath layer is improved.

Hereinabove, preferred embodiments of the present invention has been described in detail with reference to the accompanying drawings. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A composition for producing a high heat resistance insulating material, comprising:
0.5 to 10 parts by weight of a crosslinking agent based on 100 parts by weight of a fluorine-based rubber.

2. The composition for producing a high heat resistance insulating material according to claim 1,
wherein the fluorine-based rubber is any one selected from the group consisting of vinylidenefluoride hexafluoropropylene, vinylidenefluoride hexafluoropropylene tetrafluoroethylene, tetrafluoroethylene propylene, tetrafluoroethylene propylene vinylidenefluoride, tetrafluoroethylene perfluoromethylvinylether vinylidenefluoride and tetrafluoroethylene hexafluoropropylene ethylene perfluoromethylvinylether vinylidenefluoride, or mixtures thereof.

3. The composition for producing a high heat resistance insulating material according to claim 1,
wherein the crosslinking agent is any one selected from the group consisting of di-(2,4-dichlorobenzoyl)-peroxide, dibenzoyl peroxide, tert-butyl peroxybenzoate, 1,1-di-(tert-butylperoxy)-3,3,5-trimethylcyclohexane, dicumyl peroxide, tert-butylcumylperoxide, di-(2-tert-butyl-peroxyisopropyl)-benzene, 2,5-dimethyl-2,5-di-(tert-butylperoxy)-hexane, di-tert-butylperoxide and 2,5-dimethyl-2,5-di(tert-butylperoxy)hexyne-3, or mixtures thereof.

4. A composition for producing a high heat resistance insulating material,
wherein the composition defined in any one of claims 1 to 3 is used to form an insulating layer surrounding an outer surface of a center conductor of an insulated cable.

5. A composition for producing a high heat resistance insulating material, comprising:
0.5 to 10 parts by weight of a crosslinking agent based on 100 parts by weight of a basic resin,
wherein the basic resin is any one selected from the group consisting of an ethylene-based copolymer resin, a polyethylene-based resin, a styrene-based resin, a rubber, polypropylene, a polyester resin, a chloropolyethylene resin and a chlorosulfonated polyethylene, or mixtures thereof.

6. The composition for producing a high heat resistance insulating material according to claim 5,
wherein the ethylene-based copolymer resin selected as the basic resin is any one selected from the group consisting of ethylene vinyl acetate copolymer, ethylene ethyl acrylate copolymer, ethylene methyl acrylate copolymer, ethylene butyl acrylate copolymer, ethylene alcohol acrylate copolymer, ethylene butylene copolymer and ethylene octene copolymer, or mixtures thereof.

7. The composition for producing a high heat resistance insulating material according to claim 5,
wherein the polyethylene-based resin selected as the basic resin is any one selected from the group consisting of low density polyethylene, linear low density polyethylene, medium density polyethylene and high density polyethylene, or mixtures thereof.

8. The composition for producing a high heat resistance insulating material according to claim 5,
wherein the styrene-based resin selected as the basic resin is any one selected from the group consisting of styrene butylene styrene resin, styrene ethylene butylene styrene resin, styrene ethylene propylene styrene resin, or mixtures thereof.

9. The composition for producing a high heat resistance insulating material according to claim 5,
wherein the rubber selected as the basic resin is any one selected from the group consisting of an ethylene propylene rubber and a chloropropylene rubber, or mixtures thereof.

10. The composition for producing a high heat resistance insulating material according to claim 5,
wherein the crosslinking agent is any one selected from the group consisting of di-(2,4-dichlorobenzoyl)-peroxide, dibenzoyl peroxide, tert-butyl peroxybenzoate, 1,1-di-(tert-butylperoxy)-3,3,5-trimethylcyclohexane, dicumyl peroxide, tert-butylcumylperoxide, di-(2-tert-butyl-peroxyisopropyl)-benzene, 2,5-dimethyl-2,5-di-(tert-butylperoxy)-hexane, di-tert-butylperoxide and 2,5-dimethyl-2,5-di(tert-butylperoxy)hexyne-3, or mixtures thereof.

11. A composition for producing a high heat resistance insulating material,
wherein the composition defined in any one of claims 5 to 10 is used to form a sheath layer, and
wherein an insulated cable includes a center conductor, an insulating layer surrounding the center conductor, a fabric layer surrounding the insulating layer, and the sheath layer surrounding the fabric layer and serving as an outermost layer.

12. A high heat resistance insulated cable, comprising:
a center conductor;
an insulating layer surrounding the center conductor;
a fabric layer surrounding the insulating layer; and
a sheath layer surrounding the fabric layer and serving as an outermost layer,
wherein the insulating layer is formed using a composition for producing a high heat resistance insulating material defined in any one claims 1 to 3, and
wherein the sheath layer is formed using a composition for producing a high heat resistance insulating material defined in any one claims 5 to 10.
